(19) United States
(12) Patent Application Publication
(10) Pub. No.: US 2021/0146420 A1
(43) Pub. Date: May 20, 2021

(54) GUIDING METAL BANDS/STRIPS IN A BAND/STRIP PROCESSING SYSTEM

(71) Applicant: Primetals Technologies Austria GmbH, Linz (AT)

(72) Inventors: Juergen HOFER, Micheldorf (AT); Guenter KARNER, Säusenstein (AT); Wolfgang KLAUSHOFER, Ansfelden (AT)

(21) Appl. No.: 16/613,998

(22) PCT Filed: Apr. 26, 2018
(86) PCT No.: PCT/EP2018/060759

§ 371 Date: Nov. 15, 2019

(30) Foreign Application Priority Data
May 17, 2017 (EP) 17171528.7

(51) Int. Cl. B21C 47/24

(52) U.S. Cl. CPC B21C 47/247

(57) ABSTRACT

The invention relates to a band or strip guiding device (7) for guiding metal bands (B1 to B6) in a band processing system (1) between an inlet conveying section (3) and an outlet conveying section (5). The band guiding device (7) comprises two partial conveying sections (13, 15) arranged one above the other, two switch devices (17, 19) for selectively connecting the inlet conveying section (3) and the outlet conveying section (5) to one of the two partial conveying sections (13, 15), and for each partial conveying section (13, 15) an inlet-side separating device (21, 23) for severing a band (B1 to B6) arranged in the partial conveying section (13, 15), and an outlet-side separating device (22, 24) for severing a band (B1 to B6) arranged in the partial conveying section (13, 15) on the outlet side. Each switch device (17, 19) has a movable clamping device (31, 32) for fixing a band (B1 to B6) in the switch device (17, 19).

### CROSS-REFERENCE TO RELATED APPLICATIONS

The present application is a 35 U.S.C. §§ 371 national phase conversion of PCT/EP2018/060759, filed Apr. 26, 2018, the contents of which are incorporated herein by reference, which claims priority of European Patent Application No. 17171528.7 filed May 17, 2017, the contents of which are incorporated by reference herein. The PCT International Application was published in the German language.

### BACKGROUND OF THE INVENTION

The invention relates to a strip guiding device and to a method for guiding metallic strips in a strip processing system.

Strip processing systems for processing metallic strips often have different regions in which the strips are dissimilarly processed, for example a stretching/bending/straightening region for stretching/bending/straightening the strips, a pickling region for pickling the strips, a trimming shear region for trimming the strips, and/or a rolling region for rolling the strips. Those regions are passed in sequence by a strip. For reasons of process technology it may be expedient to be able to bypass individual regions, to guide a strip past individual regions so as to be able to process a strip by way of only part of the regions.

CN 204058549 U discloses an annealing furnace bypass device which has on the entry and on the exit side a group of draw rollers, a shear machine, a clamping roller, and a welding platform.

JP H07113155 A discloses a pickling and galvanizing system for a strip, and after a pickling region and by way of a turnout, the strip can be directed either into a galvanizing region or onto a bypass track. These two paths are merged again after the galvanizing region.

JP 563114925 A discloses a strip deflection unit for deflecting the strip about an annealing furnace, wherein by means of repositionable deflection rollers, a strip can be deflected onto a route above the annealing furnace.

For a rapid changeover between guiding the strip through and past a heat treatment furnace disposed downstream of a zinc plating line, JP 556009360 A discloses individual strip clamping devices, strip severing and connection devices, drive rollers which are rotatable in a reversible manner and enable a step-by-step movement of the strip, as well as displaceable and pivotable guide tables.

### SUMMARY OF THE INVENTION

The invention is based on the objects of specifying a strip guiding device and a method for guiding metallic strips in a strip processing system, wherein the strip guiding device and the method enables a path of the strips through the strip processing system to be varied.

A strip guiding device according to the invention is for guiding metallic strips in a strip processing system between an inlet conveying section and an outlet conveying section. The device comprises two conveying sub-sections disposed one on top of the other. An inlet-side turnout device selectively connects the inlet conveying section to an inlet-side conveying sub-section end of one of the two conveying sub-sections. An outlet-side turnout device selectively connects the outlet conveying section to an outlet-side conveying sub-section end of one of the two conveying sub-sections. For each conveying sub-section, one inlet-side separation device for the inlet-side severing of a strip disposed in the conveying sub-section and one outlet-side separation device for the outlet-side severing of a strip are disposed in the conveying sub-section. Each turnout device has a movable clamping device for fixing a strip in the turnout device.

The strip guiding device enables a strip to be selectively guided by one of the conveying sub-sections between the inlet conveying section and the outlet conveying section. The separation devices herein enable a strip that is guided through a conveying sub-section to be severed. The turnout devices enable strip ends of strips which are disposed in the inlet conveying section or the outlet conveying section to be moved from one conveying sub-section to the other conveying sub-section so as to deflect the strips to the other conveying sub-section. To this end, each turnout device has a clamping device so as to fix the respective strip end in the turnout device.

The strip guiding device enables a first of the conveying sub-sections to be bypassed, in that a strip is directed by way of the second conveying sub-section. A first strip disposed in the strip processing system can be severed herein in the first conveying sub-section, and the strip portion lying in front of the strip guiding device can subsequently be guided through the second conveying sub-section. Alternatively however, a further second strip which is not to be guided through the first conveying sub-section can also be guided by the second conveying sub-section into the strip processing system and can be processed behind the strip guiding device. For example, a pickling device for pickling strips can be disposed in the first conveying sub-section. In this specific application, a strip portion of a strip that is not to be pickled, or a further strip that is not to be pickled or has already been pickled, can be guided by the second conveying sub-section.

Either no strip or only one strip, but not two strips, is advanced through this apparatus at any one time. That one strip is advanced by the inlet conveying section, possibly deflected by the turnout device, guided through the first conveying sub-section, severed from the strip after the first conveying subsection and after processing, and guided through the outlet conveying section. As the foregoing is performed on the first strip, a second strip, which may or may not be present in the second conveying subsection, is not being advanced.

One design embodiment of the invention provides that one inlet-side separation device for the inlet-side severing of a strip that is disposed in the conveying sub-section is disposed so as to be fixed in location on each conveying sub-section. An alternative design embodiment of the invention thereto provides an inlet-side separation device for the inlet-side severing of strips disposed in the conveying sub-sections, wherein the inlet-side separation device is movable between the conveying sub-sections. In comparison to the second-mentioned design embodiment of the invention, the first-mentioned design embodiment has the advantage that no inlet-side separation device, which usually has a large mass, needs to be moved. In comparison to the first-mentioned design embodiment, the second-mentioned design embodiment of the invention reduces the number of required separation devices.

Accordingly, an outlet-side separation device for the outlet-side severing of a strip disposed in the conveying sub-section can be disposed so as to be fixed in location on each conveying sub-section, or an outlet-side separation device for the outlet-side severing of strips disposed in the conveying sub-sections can be provided, wherein the outlet-side separation device is movable between the conveying sub-sections.

In a further design embodiment of the invention, each separation device has at least one pair of circular knives having an upper knife and a lower knife wherein the upper knife and the lower knife, extending transversely to a strip running direction of a strip, are capable of traveling in a synchronous and mutually parallel manner across the strip, wherein the upper knife is disposed above the strip and the lower knife is disposed below the strip. The embodiment of a separation device having a pair of circular knives, in comparison to an embodiment having only one circular knife, for example, has the advantage that the cutting force of the circular knives is relatively low and the weight of the circular knives can be kept relatively low.

In particular, each separation device can have two pairs of circular knives which are disposed so as to be mutually spaced apart in the strip running direction. Separation devices having two mutually spaced apart pairs of circular knives when severing a strip, enable a band to be cut from a strip. This facilitates any later manual connecting of strip ends of two strips, since an operator can stand between the strip ends when connecting the strip ends. Manual connecting of strip ends of two strips can be performed, for example, by punching the strip ends using connection plates, by welding the strip ends using connection plates, by welding overlapping strip ends, or by butt-welding or punching the strip ends.

However, other separation devices, in particular separation devices which are manually movable and which are disposed on the inlet side and the outlet side on the conveying sub-sections, can also be provided instead of separation devices which have one pair or a plurality of pairs of circular knives.

One further embodiment of the invention provides that one inlet-side clamping device and one outlet-side clamping device for fixing a strip in the conveying sub-section are disposed on each conveying sub-section so as to be fixed in location or displaceable parallel to a strip running direction of a strip.

This design embodiment of the invention advantageously enables strips to be fixed in the conveying sub-sections so as to prevent any slipping of the strips in the conveying sub-sections.

One further embodiment of the invention provides that at least one clamping device has two strip clamps for fixing a strip, the strip clamps, transversely to a strip running direction of the strip, being disposed on different sides of the strip so as to be mutually opposite. The strip clamps have in each case two clamping jaws which are displaceable transversely to the strip running direction. A lateral peripheral region of the strip is capable of being clamped between the clamping jaws such that one of the two clamping jaws bears on an upper side of the peripheral region, and the other clamping jaw bears on a lower side of the peripheral region. This embodiment of the invention enables a clamping device to be adapted to the width of a strip by displacing the clamping jaws transversely to the strip running direction of the strip. However, instead of two strip clamps, a clamping device can also have another number of strip clamps, for example also only one strip clamp which jams a central region of a strip or clamps the strip along the entire width thereof.

Alternatively or additionally, at least one clamping device can include two clamping rollers between which a strip is capable of being clamped such that one of the two clamping rollers bears on an upper side of the strip and the other clamping roller bears on a lower side of the strip and wherein at least one clamping roller is capable of being driven. A clamping roller capable of being driven herein is understood to be rotatable about its longitudinal axis by a drive. A clamping device designed in such a manner advantageously enables displacement of a clamped strip by at least one clamping roller capable of being driven, for example so as to position the strip end of the strip for connecting to the strip end of another strip.

One further design embodiment of the invention provides one connection device for connecting strip ends of two strips. It is disposed at each of the inlet side and the outlet side on each conveying sub-section. This design embodiment of the invention enables a strip disposed in a conveying sub-section to be connected at the inlet side to a strip disposed in the inlet conveying section, and to be connected at the outlet side to a strip disposed in the outlet conveying section, the connecting being performed in an automated manner, by a connection device. Alternatively however the strips may be manually connected.

A strip processing system according to the invention has an inlet conveying section, an outlet conveying section, and a strip guiding device according to the invention for guiding metallic strips. Advantages of a strip processing system of this type are derived from the above-mentioned advantages of a strip guiding device according to the invention.

In a method according to the invention for guiding metallic strips in a strip processing system between an inlet conveying section and an outlet conveying section using a strip guiding device according to the invention, a first strip, which is disposed in the inlet conveying section, the outlet conveying section, and in a first conveying sub-section, by the movable clamping device of the inlet-side turnout device, is fixed in the inlet-side turnout device, and, by the movable clamping device of the outlet-side turnout device, is fixed in the outlet-side turnout device. The first strip is subsequently severed by an inlet-side separation device and by an outlet-side separation device, whereby the first strip is divided into an inlet-side third strip having a strip end that is fixed in the inlet-side turnout device, an outlet-side fourth strip having a strip end that is fixed in the outlet-side turnout device, and a fifth strip that is disposed in the first conveying sub-section. Thereafter, the strip end of the third strip, by way of the inlet-side turnout device, is moved to the inlet-side conveying sub-section end of the second conveying sub-section, and the strip end of the fourth strip, by way of the outlet-side turnout device, is moved to the outlet-side conveying sub-section end of the second conveying sub-section. While the foregoing is being performed on the first strip, the second strip in the second conveying subsection, if any, is not being advanced.

The method according to the invention enables the diversion of a first strip guided through a first conveying sub-section through the second conveying sub-section. More specifically, the method enables the diversion of the portion of the first strip that lies in front of the strip guiding device through the second conveying sub-section. To this end, upon the fixing of the first strip in the turnout devices, the first strip is severed at the inlet side and at the outlet side in the first conveying sub-section. The strip ends of the inlet-side third strip created herein and of the outlet-side fourth strip created herein are subsequently moved by the turnout device to the second conveying sub-section.

In one design embodiment of the method, prior to the severing of the first strip, the first strip, is fixed in the first conveying sub-section by an inlet-side clamping device and an outlet-side clamping device. On account of this, slipping of the first strip in the first conveying sub-section during and after the severing of the first strip is advantageously prevented.

In one further design embodiment of the method, when a second strip is disposed in the second conveying sub-section, the strip end of the third strip is connected to the inlet-side strip end of the second strip, and the strip end of the fourth strip is connected to the outlet-side strip end of the second strip. As a result, the second strip, the third strip, and the fourth strip are connected so as to form a contiguous sixth strip which can subsequently be run through the strip processing system. The sixth strip assumes the role of the first strip, but in contrast to the latter, the sixth strip is guided by the second conveying sub-section instead of the first sub-section. Accordingly, a portion of the sixth strip lying in front of the strip guiding device can later be diverted into the first conveying sub-section again, wherein the roles of the conveying sub-sections are swapped and the fifth strip remaining in the first conveying sub-section assumes the role of the second strip.

The above-described properties, features, and advantages of this invention as well as the manner in which said properties, features, and advantages are achieved, will become more evident and more clearly comprehensive in the context of the description hereunder of exemplary embodiments which are explained in more detail in conjunction with the drawings in which:

### BRIEF DESCRIPTION OF THE DRAWINGS

FIG. 1 schematically shows a lateral view of a strip processing system;

FIG. 2 schematically shows a strip guiding device for guiding metallic strips;

FIG. 3 shows a first illustration of strips in a strip guiding device;

FIG. 4 shows a second illustration of strips in a strip guiding device;

FIG. 5 shows a third illustration of strips in a strip guiding device;

FIG. 6 shows a fourth illustration of strips in a strip guiding device;

FIG. 7 shows a fifth illustration of strips in a strip guiding device;

FIG. 8 shows a sixth illustration of strips in a strip guiding device;

FIG. 9 shows a perspective illustration of a strip clamp;

FIG. 10 schematically shows a sectional illustration of a separation device and of a strip;

FIG. 11 schematically shows a lateral view of a movable clamping device and of two separation devices;

FIG. 12 schematically shows a sectional illustration of a turnout device; and

FIG. 13 schematically shows a sectional illustration of a second exemplary embodiment of a clamping device.

### DESCRIPTION OF EMBODIMENTS

Mutually equivalent parts are provided with the same reference signs in the Figures.

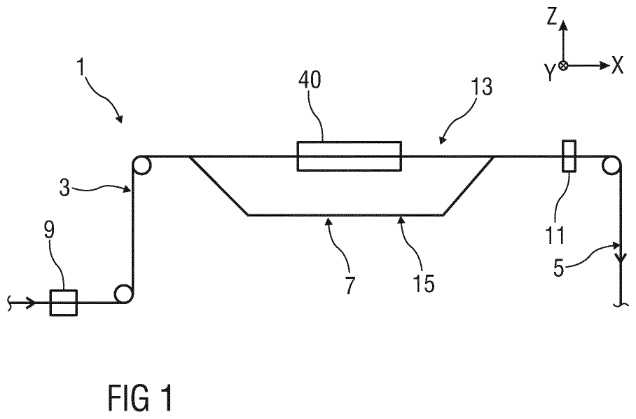

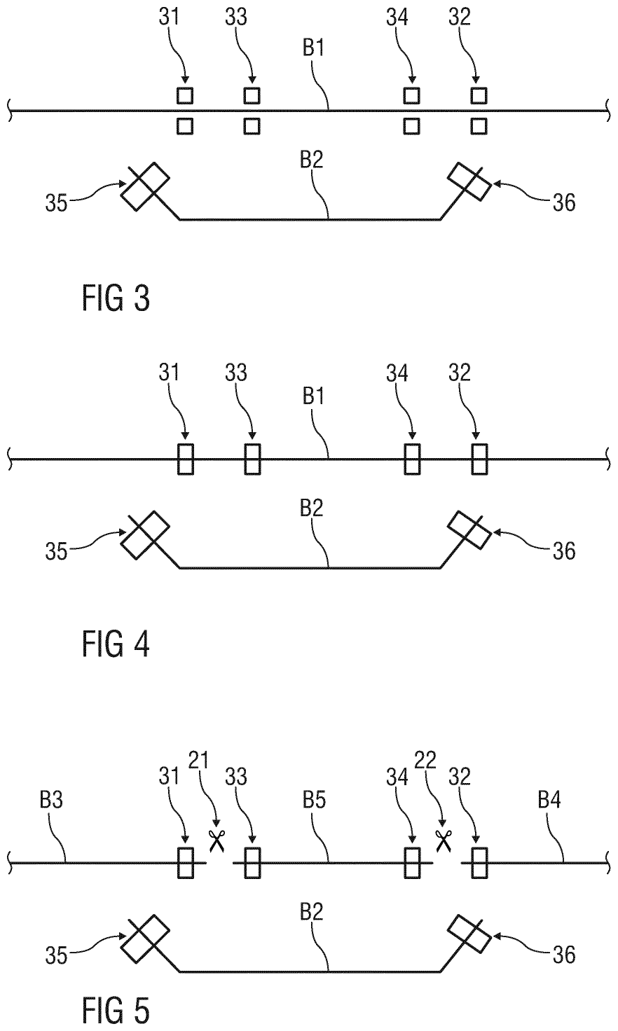

FIG. 1 schematically shows a lateral view of a strip processing system 1. The strip processing system 1 comprises an inlet conveying section 3, an outlet conveying section 5, and a strip guiding device 7 for guiding metallic strips. Referring to FIG. 1, every strip which is to be conveyed through the strip processing system 1 is a ‘continuous unbroken’ strip 1 that enters the strip processing system 1 via the inlet conveying section 3, leaves it via the outlet conveying section 5 and has a length that is usually much longer (up to several kilometers) than each of the conveying sub-sections 13 and 15. As such, a ‘short’ strip like B2 or B5 in FIGS. 3 to 8 only constitutes a residual part that was cut out of such a continuous strip via some of the separation devices 21-24

For example, a stretching/bending/straightening device 9 for stretching/bending/straightening strips is disposed in the inlet conveying section 3.

For example, a trimming shear 11 for trimming strips is disposed in the outlet conveying section 5. For example, a tandem line for cold-rolling strips follows the outlet conveying section 5.

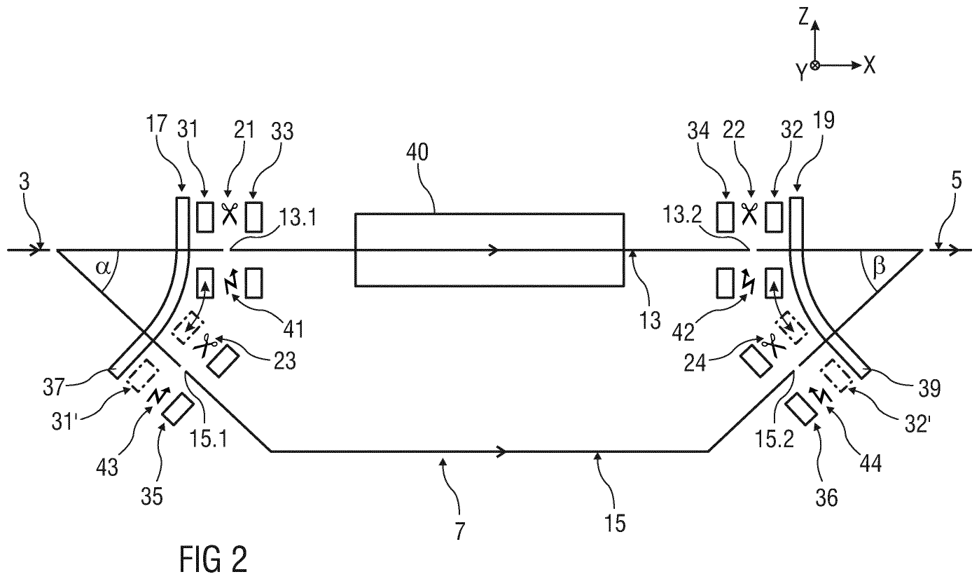

FIG. 2 schematically shows the strip guiding device 7. The strip guiding device 7 has two conveying sub-sections 13, 15 disposed one on top of the other, an inlet-side turnout device 17, an outlet-side turnout device 19, four strip separation devices 21 to 24, and six clamping devices 31 to 36.

A pickling device 40 for pickling strips is disposed in the upper conveying sub-section 13. For example, the pickling device 40 has at least one pickling tank which is capable of being filled with a pickling medium and into which a strip is capable of being introduced. A strip running direction in the upper conveying sub-section 13 defines an X direction of a Cartesian coordinate system having coordinates X, Y, Z. The Y direction of the coordinate system runs parallel to a strip transverse direction of a strip guided in the upper conveying sub-section 13.

The lower conveying sub-section 15 is disposed below the first conveying sub-section 13 and serves for guiding a strip, which is not to be pickled, past the pickling device 40 between the inlet conveying section 3 and the outlet conveying section 5.

For example, the conveying sub-sections 13, 15 have roller tracks for guiding a strip.

In alternative exemplary embodiments of the strip guiding device 7, alternatively or additionally to the pickling device 40, at least one other or further, respectively, strip processing device can be disposed in the upper conveying sub-section 13. Furthermore, at least one strip processing device, for example a further pickling device 40, can also be disposed in the lower conveying sub-section 15, so as to pickle a strip guided through the lower conveying sub-section 15 by another pickling medium than a strip guided through the upper conveying sub-section 13.

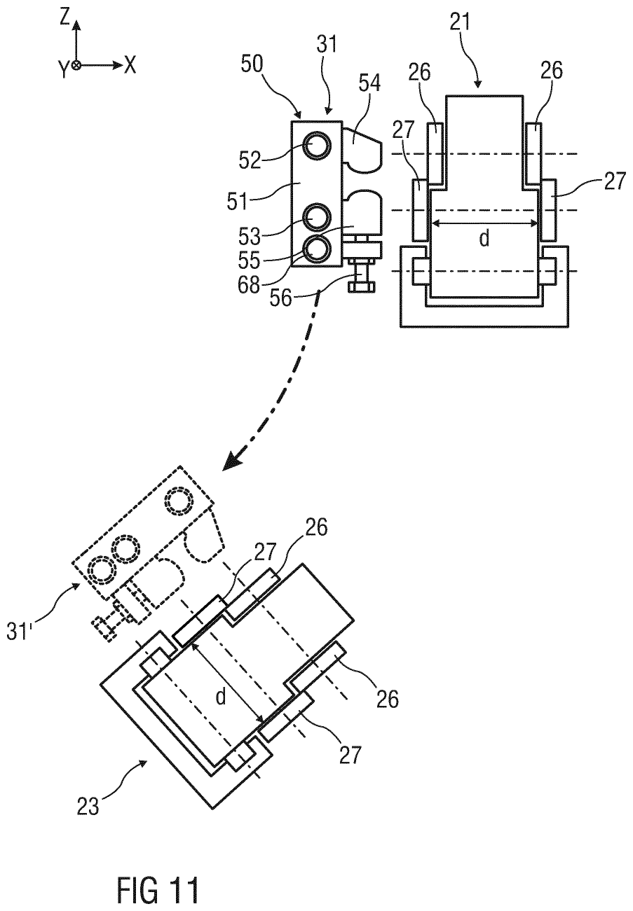

The inlet-side turnout device 17 is configured for selectively connecting the inlet conveying section 3 to an inlet-side conveying sub-section end 13.1 of the upper conveying sub-section 13, or to an inlet-side conveying sub-section end 15.1 of the lower conveying sub-section 15. The inlet-side turnout device 17 moves the leading strip end to the selected one of the inlet side upper conveying sub-section 13 or to the inlet side lower conveying sub-section 15. Advancement of the strip then at the inlet conveying section 3 and that has not yet been moved by the turnout device 17 to the other one of the inlet-side upper or lower conveying sub-section is halted. While one strip is advancing along the one of the upper or lower conveying sub-section, advancement of the next strip is halted and is stopped from advancing into the inlet conveying station 3. Only one strip should be advanced. Only one strip at a time moves through the apparatus at the same time. That one of the two strips advances only when it forms a continuous strip through the upper conveying sub-section 13 or through the lower conveying sub-section 15. In either case, only strip B1 in FIGS. 3 and 4 can advance. In FIGS. 7 and 8, only strip B6 can advance. The inlet-side turnout device 17 has a first clamping device 31 for fixing a strip in the inlet-side turnout device 17. The first clamping device 31 is pivotable about a first pivot angle α between a first terminal position, in which the inlet-side turnout device 17 connects the inlet conveying section 3 to the upper conveying sub-section 13, and a second terminal position, in which the inlet-side turnout device 17 connects the inlet conveying section 3 to the lower conveying sub-section 15 (cf. also FIG. 11 to this end). The second terminal position of the first clamping device 31 is indicated by dashed lines in FIG. 2 and is identified by the reference sign 31′. For pivoting the first clamping device 31, the inlet-side turnout device 17 has a first pivot guide 37 by way of which the first clamping device 31 is guided.

The outlet-side turnout device 19 is configured for selectively connecting the outlet conveying section 5 to an outlet-side conveying sub-section end 13.2 of the upper conveying sub-section 13, or to an outlet-side conveying sub-section end 15.2 of the lower conveying sub-section 15. The outlet-side turnout device 19 has a second clamping device 32 for fixing a strip in the outlet-side turnout device 19. The second clamping device 32 is pivotable about a second pivot angle β between a first terminal position in which the outlet-side turnout device 19 connects the outlet conveying section 5 to the upper conveying sub-section 13, and a second terminal position in which the outlet-side turnout device 19 connects the outlet conveying section 5 to the lower conveying sub-section 15. The second terminal position of the second clamping device 32 is indicated by dashed lines in FIG. 2 and is identified by the reference sign 32′. For pivoting the second clamping device 32, the outlet-side turnout device 19 has a second pivot guide 39 by way of which the second clamping device 32 is guided.

A third clamping device 33 on the inlet side, and a fourth clamping device 34 on the outlet side, are disposed so as to be fixed in their locations on the upper conveying sub-section 13 in order for a strip to be fixed on the upper conveying sub-section 13.

Furthermore, a first separation device 21 on the inlet side, and a second separation device 22 on the outlet side, are disposed so as to be fixed in their positions on the upper conveying sub-section 13. The first separation device 21 is disposed between the first terminal position of the first clamping device 31 and the third clamping device 33. The second separation device 22 is disposed between the first terminal position of the second clamping device 32 and the fourth clamping device 34. The first separation device 21 and the second separation device 22 are configured for severing a strip disposed in the upper conveying sub-section 13.

A fifth clamping device 35 on the inlet side, and a sixth clamping device 36 on the outlet side, are disposed so as to be fixed in their locations on the lower conveying sub-section 15 in order for a strip to be fixed on the lower conveying sub-section 15.

Furthermore, a third separation device 23 on the inlet side, and a fourth separation device 24 on the outlet side, are disposed so as to be locationally fixed on the lower conveying sub-section 15. The third separation device 23 is disposed between the second terminal position of the first clamping device 31 and the fifth clamping device 35. The fourth separation device 24 is disposed between the second terminal position of the second clamping device 32 and the sixth clamping device 36. The third separation device 23 and the fourth separation device 24 are configured for severing a strip disposed in the lower conveying sub-section 15.

The clamping devices and the separation devices support a strip while it is processed, clamp after the strip advance has been halted and separate the strip into selected length while it is clamped.

Optionally, the strip guiding device 7 furthermore has four connection devices 41 to 44 which are in each case configured for connecting strip ends of two strips in an automated manner. A first connection device 41 on the inlet side is disposed on the upper conveying sub-section 13 between the first terminal position of the first clamping device 31 and the third clamping device 33. A second connection device 42 on the outlet side is disposed on the upper conveying sub-section 13 between the first terminal position of the second clamping device 32 and the fourth clamping device 34. A third connection device 43 is disposed between the second terminal position of the first clamping device 31 and the fifth clamping device 35. The fourth connection device 44 is disposed between the second terminal position of the second clamping device 32 and the sixth clamping device 36. For example, the connection devices 41 to 44 are embodied as punching devices for punching strip ends to be connected using connection plates, or as welding devices for welding strip ends to be connected using connection plates.

Instead of the connection devices 41 to 44, the strip ends of two strips may be manually connected using corresponding connection tools, for example by punching strip ends to be connected using connection plates, or by welding strip ends to be connected using connection plates.

Furthermore, instead of the four separation devices 21 to 24 disposed so as to be fixed in their locations on the conveying sub-sections 13, 15, one movable separation device can in each case be provided on the inlet side and the outlet side, wherein the inlet-side separation device is movable between the inlet-side conveying sub-section ends 13.1, 15.1 of the conveying sub-sections 13, 15, and the outlet-side separation device is movable between the outlet-side conveying sub-section ends 13.2, 15.2 of the conveying sub-sections 13, 15.

FIGS. 3 to 8 illustrate the method according to the invention for guiding metallic strips B1 to B6 in a strip processing system 1 at various stages of the method. The entire apparatus is shown also in FIG. 2.

In order for the method to be described, an initial situation as shown in FIG. 3 is assumed. A first continuous unbroken strip B1 herein in FIG. 3 is disposed in the inlet conveying section 3, the outlet conveying section 5, and the upper conveying sub-section 13, that is, the first strip B1 extends from the inlet conveying section 3 through the upper conveying sub-section 13 into the outlet conveying section 5. The continuous unbroken strip B1 in FIG. 3 stops in order to be clamped as depicted in FIG. 4.

Furthermore, a second strip B2 is disposed in the lower conveying sub-section 15 and by way of the fifth clamping device 35 and the sixth clamping device 36 is fixed in the lower conveying sub-section 15.

The strips B1 and B2 of FIG. 3 can be considered as separate strips, whereby the part between the clamping devices 33 and 34 of strip B1 is cut off from the leading and trailing part and becomes B5; the leading and trailing parts of former strip B1 get the designation B4 and B3, respectively and are connected to the strip B2 which is already present in the lower conveying sub-section 15 to form the ‘new’ continuous strip B6.

B2 is the leftover piece from a strip that was conveyed through the strip processing system 1 via the lower conveying sub-section 15 at some earlier instant.

Strip B2 in FIG. 3 is the remnant of a formerly continuous, unbroken strip that was guided through the strip processing system 1 via the lower conveying sub-section 15 and was cut off from its leading and trailing parts in the same manner as is disclosed in the description of FIGS. 3-8.

Such a residual strip is usually declassified as scrap because of its short length and/or because it has been stopped in a processing unit such as the pickling device 40 in FIG. 1 and therefore lost its dedicated properties. A residual strip therefore usually only serves as a mechanical bridging part between strip ends of ‘unbroken’ strips in the inlet and outlet conveying section 3 and 5. If no residual strip like B2 and B5 is left in a conveying sub-section, every subsequent ‘unbroken’ strip must be threaded through the respective conveying sub-section 13 or 15 anew, which constitutes a huge work load. Therefore, by sacrificing a residual strip part such as B2 or B5 and declassifying it to scrap, these residual strips constitute mechanical bridging parts to which ‘unbroken’ strips can easily be connected, thereby enhancing the overall operational capacity of a strip processing system and enabling two possible routes through a strip processing system for a continuous strip.

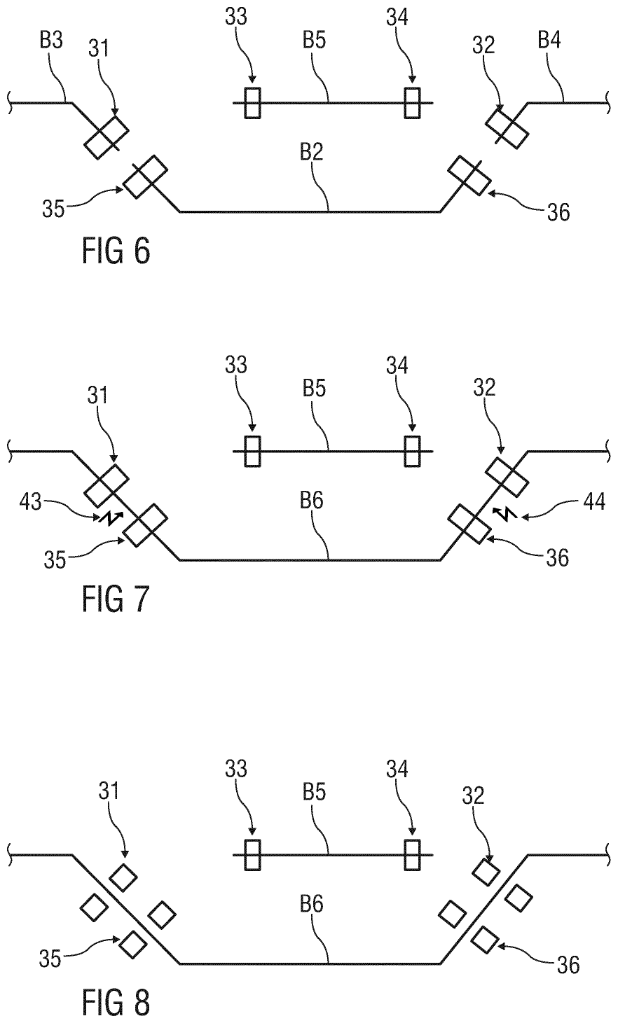

The strip 15, B2 in the lower conveying sub-section 15 entered processing system 1 via the inlet conveying section 3 when it was part of an earlier, unbroken strip and will leave sub-section 15 as part of the new strip B6 (FIGS. 7 and 18) via the outlet conveying section 5 at some later point in time after it has been connected to respective strip ends as depicted in the transition of FIG. 6 to FIG. 7.

An ‘unbroken’ strip usually has a length much longer than the conveying sub-sections; one might add that although not explicitly stated in the Specification—strips that are conveyed through the strip processing system 1 in succession are usually welded together to form an “endless strip” as one might deduce from FIG. 1.

Each strip, of continuous embodiment or in the form of a short piece such as B2 or B5, has entered the strip processing system 1 via the inlet conveying section 3.

As noted above, only the inlet conveying section 3 serves as the only source for any strip. While strip B1 in FIG. 3 represents a strip along the first of two possible routes through the strip processing system 1, strip B6 in FIGS. 7 and 8 represents a strip that is conveyed along the second possible route through the strip processing system 1. Since strip B6 is the result of the merger of the ‘residual strip’ B2 with the ends of continuous strips B3 and B4 in the inlet and outlet conveying sections 3 and 5, respectively, it becomes clearer that any strip leaves the strip processing system 1 only in the form of a ‘continuous’ strip. In that respect, the sequence of FIGS. 3 to 8 represents the transition for a ‘continuous strip’ through the strip processing system 1 from one possible route to the other possible route. The route can be changed again via a likewise sequence of steps.

In order for a strip portion of the first strip B1 that is disposed in the inlet conveying section 3 to be guided past on the upper conveying sub-section 13, the following procedure applies.

First, the first strip B1 is clamped by the clamping devices 31 to 34, according to FIG. 4. The stopping of that strip is not caused by the clamps themselves but by the conveying mechanism of the strip before the clamping takes place. The first strip B1 is thereby fixed in the inlet-side turnout device 17 by the first clamping device 31, fixed in the outlet-side turnout device 19 by the second clamping device 32, and fixed in the upper conveying sub-section 13 by the third clamping device 33 and the fourth clamping device 34. Only a non-clamped strip is able to move.

All four clamping devices 31-34 in FIG. 4 are activated just for enabling the joining the respective strip ends between the devices 31/33 and 32/34 and to prevent the otherwise loose strip ends from falling out of the respective conveying sections. A strip is only securely held if its ends are mechanically fixed to a certain device: In the case of a short strip such as B2, it is the clamping devices 35 and 36. In the case of a continuous strip, such as B1 of FIG. 3, those fixing devices are not further specified because they are located outside the strip processing system 1: For instance, those devices could be a coil winding devices (coiler mandrel) or further clamping devices not shown in any of the FIGS. 1-8.

Subsequently, as shown in FIG. 5, the first strip B1 is severed by the first separation device 21 and by the second separation device 22. As illustrated in FIG. 5, the first strip B1 is thereof divided into an inlet-side third strip B3 having a strip end fixed in the inlet-side turnout device 17, an outlet-side fourth strip B4 having a strip end fixed in the outlet-side turnout device 19, and a fifth strip B5 disposed in the upper conveying sub-section 13.

Thereafter, the strip end of the third strip B3 that is fixed in the inlet-side turnout device 17 is pivoted by the inlet-side turnout device 17 toward the inlet-side conveying sub-section end 15.1 of the lower conveying sub-section 15, and the strip end of the fourth strip B4 that is fixed in the outlet-side turnout device 19 is pivoted by way of the outlet-side turnout device 17 toward the outlet-side conveying sub-section end 15.2 of the lower conveying sub-section 15. FIG. 6 shows the result.

Subsequently, as shown in FIG. 7, the inlet-side strip end of the second strip B2 is connected to the strip end of the third strip B3 that is fixed in the inlet-side turnout device 17, and the outlet-side strip end of the second strip B2 is connected to the strip end of the fourth strip B4 that is fixed in the outlet-side turnout device 19 (in each case either manually or by way of connection devices 43, 44). As a result, the second strip B2, the third strip B3, and the fourth strip B4 are connected so as to form a contiguous sixth strip B6 which extends from the inlet conveying section 3 through the lower conveying sub-section 15 into the outlet conveying section 5. FIG. 7 shows the result.

Strip B2 has stopped advancing from FIG. 3 to FIG. 7. From then on, it has become part of the newly generated continuous strip B6, which can resume movement in FIG. 8. B2 was stopped at some undefined, earlier instant, while B1 was stopped in the transition between FIGS. 3 and 4 before being clamped.

Thereafter, the clamped locations of the sixth strip B6 are released by the first clamping device 31, the second clamping device 32, the fifth clamping device 35, and the sixth clamping device 36. FIG. 8 shows the result. The sixth strip B6 is guided in the lower conveying sub-section 15 between the inlet conveying section 3 and the outlet conveying section 5.

The sixth strip B6 assumes the role of the first strip B1, but in contrast to the latter, strip B6 is guided by way of the lower conveying sub-section 15 instead of by way of the upper conveying sub-section 13.

In order to return from the situation shown in FIG. 8 to the situation shown in FIG. 3, the procedure is applied in an analogous manner, wherein the roles of the conveying sub-sections 13, 15 are reversed and the fifth strip B5 that has remained in the upper conveying sub-section 13 assumes the role of the second strip B2.

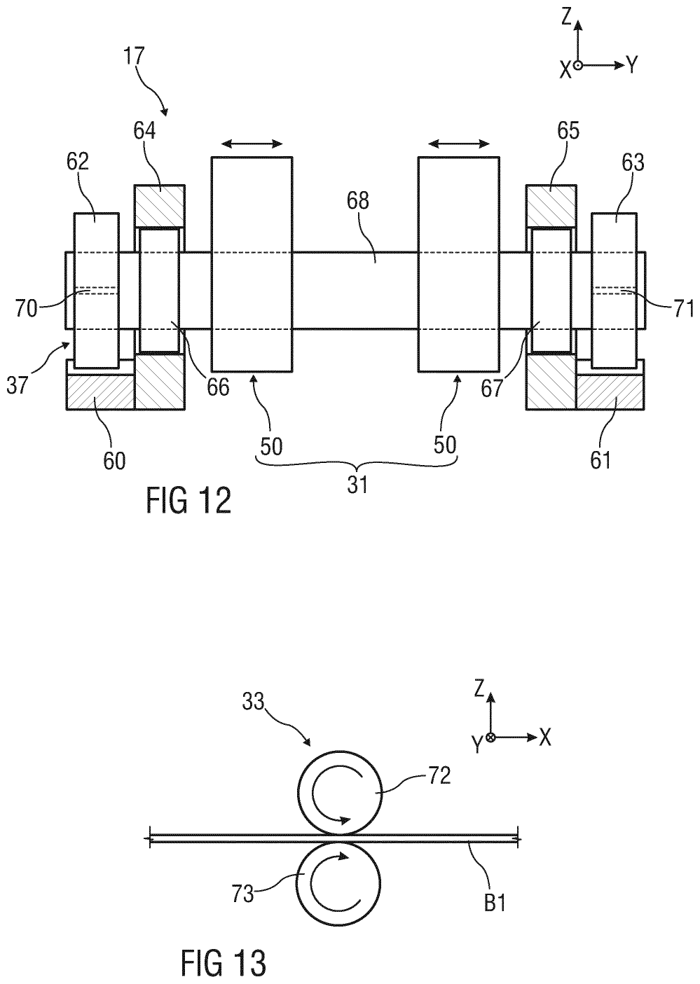

For example, a clamping device 31 to 36 has two strip clamps 50 for fixing a strip. The two strip clamps 50 are disposed transversely to a strip running direction of the strip are disposed so as to be mutually opposite on different sides of the strip and so as to be displaceable transversely to the strip running direction (cf. also FIG. 12 to this end).

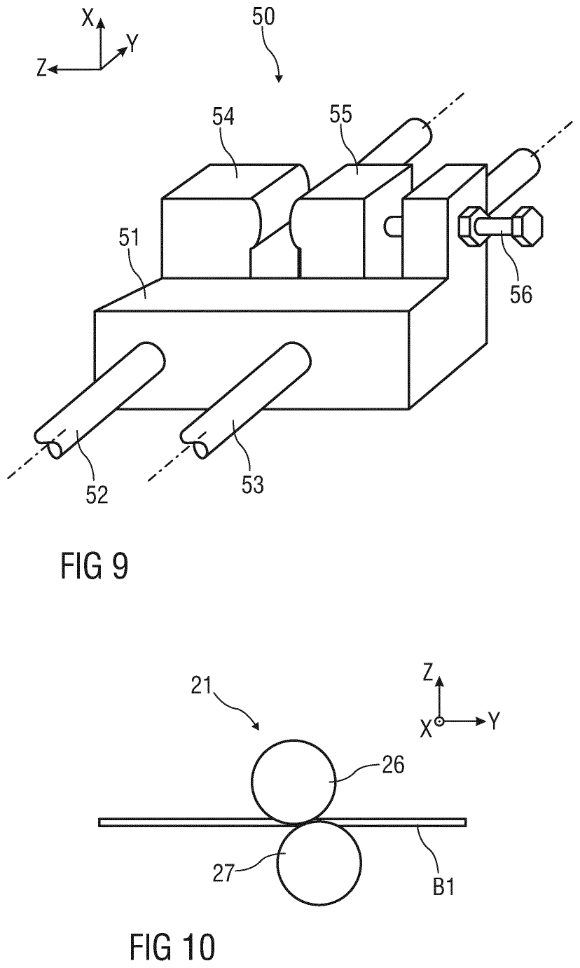

FIG. 9 shows a perspective illustration of an exemplary embodiment of a strip clamp 50 of a clamping device 33, 34 disposed on the upper conveying sub-section 13.

The strip clamp 50 has a clamping member 51, two guide bars 52, 53, two clamping jaws 54, 55, and a contact pressure element 56.

The guide bars 52, 53 are guided so as to be mutually parallel through the clamping member 51. The clamping member 51, in the strip transverse direction of a strip to be clamped by the strip clamp 50, is displaceable along the guide bars 52, 53 such that the position of the clamping member 51 is capable of being adapted to the width of the strip. A strip produced runs herein through between the guide bars 52, 53.

A first clamping jaw 54 is fixedly connected to the clamping member 51, or is embodied so as to be integral with the clamping member 51. The second clamping jaw 55 is mounted so as to be rotatable about a guide bar 53 which is guided through the second clamping jaw 55. The contact pressure element 56 is configured for pressing the second clamping jaw 55 onto a peripheral region of a strip that lies between the clamping jaws 54, 55 such that the peripheral region is clamped between the clamping jaws 54, 55, wherein one of the two clamping jaws 54, 55 bears on an upper side of the peripheral region, and the other clamping jaw 54, 55 bears on a lower side of the peripheral region. For example, the contact pressure element 56 is configured as a screw element disposed on the clamping member 51.

The strip clamps 50 of other clamping devices 31, 32, 35, 36 can be embodied like the strip clamp 50 illustrated in FIG. 9, whereas the strip clamps 50 of the clamping devices 35, 36 are however aligned differently in relation to the coordinate system. The movable clamping devices 31, 32 can be aligned differently as a function of the position of the clamping devices 31, 32, respectively. For in the movable clamping devices 31, 32, a transverse shaft 68, in addition to the guide bars 52, 53, can be guided through the clamping member 51 so as to be parallel to the guide bars 52, 53, cf. end FIGS. 11 and 12.

FIG. 10 schematically shows a sectional illustration of the separation device 21 and of a strip B1. The separation device 21 has two pairs of circular knives which in a strip running direction of the strip B1 are disposed so as to be mutually spaced apart (cf. to this end FIG. 11). Each pair of circular knives includes an upper knife 26 and a lower knife 27 which, transversely to a strip running direction, are capable of traveling in a synchronous and mutually parallel manner across the strip B1, wherein the upper knife 26 is disposed above the strip B1 and the lower knife 27 is disposed below the strip B1.

FIG. 11 schematically shows a lateral view of the first clamping device 31 in both terminal positions thereof as well as of the first separation device 21 and the third separation device 23. The two pairs of circular knives of each separation device 21 to 24 are disposed at a mutual spacing d. On account thereof, a band of width d is cut from the strip by each separation device 21 to 24 when severing a strip. This facilitates manually connecting strip ends of two strips, for example by punching strip ends to be connected using connection plates, or by welding strip ends to be connected using connection plates.

FIG. 12 schematically shows a sectional illustration of the inlet-side turnout device 17. The first pivot guide 37 has two toothed segments 60, 61, two gear wheels 62, 63, two gates 64, 65, two rollers 66, 67, and a transverse shaft 68.

A first toothed segment 60, a first gear wheel 62, a first gate 64, and a first roller 66 are disposed on a first side of the first clamping device 31. A second toothed segment 61, a second gear wheel 63, a second gate 65, and a second roller 67. The second one of those elements is disposed on the second side of the first clamping device 31, which is opposite the first side. The first gear wheel 62 is guided in the first toothed segment 60. The second gear wheel 63 is guided in the second toothed segment 61. The first roller 66 is guided in the first gate 64. The second roller 67 is guided in the second gate 65. The rollers 66 and 67 are in each case connected to a strip clamp 50 of the first clamping device 31 and by way of the transverse shaft 68 are coupled to one another and coupled to the gear wheels 62, 63. Each gear wheel 62, 63 is coupled to the transverse shaft 68 by a coupling element 70, 71. Alternatively, instead of being coupled by a separate transverse shaft 68, rollers 66 and 67 and the gear wheels 62, 63 can also be coupled to one another by a guide bar 52, 53 of the first clamping device 31. In this case, that one of the guide bars 52, 53 which does not assume the function of the transverse shaft 68 is coupled to the rollers 66 and 67. In the embodiment having a separate transverse shaft 68, both guide bars 52, 53 are coupled to the rollers 66, 67.

FIG. 13 schematically shows a sectional illustration of a second exemplary embodiment of a clamping device 33 disposed on the upper conveying sub-section 13. The clamping device 33 has two clamping rollers 72, 73 between which a strip B1 is capable of being clamped. The first clamping roller 72 bears on an upper side of the strip B1 and the second clamping roller 73 bears on a lower side of the strip B1. At least one clamping roller 72, 73 is capable of being driven. Other clamping devices 31, 32 and 34 to 36 can be embodied like the clamping device 33 illustrated in FIG. 13, whereas the other clamping devices in the case of the clamping devices 35, 36 are however aligned differently in relation to the coordinate system, or in the case of the movable clamping devices 31, 32 can be aligned differently as a function of the positions of said clamping devices 31, 32, respectively.

While the invention has been illustrated and described in detail by way of preferred exemplary embodiments, the invention is not limited to the disclosed examples, and other variations can be derived therefrom by a person skilled in the art without departing from the scope of protection of the invention.

### LIST OF REFERENCE SIGNS

1 Strip processing system
3 Inlet conveying section
5 Outlet conveying section
7 Strip guiding device
9 Stretching/bending/straightening device
11 Trimming shear
13, 15 Conveying sub-section
13.1, 15.1 Inlet-side conveying sub-section end
13.2, 15.2 Outlet-side conveying sub-section end
17, 19 Turnout device
21 to 24 Separation device
26 Upper knife
27 Lower knife
31 to 36, 31′, 32′ Clamping device
37, 39 Pivot guide
40 Pickling device
41 to 44 Connection device
50 Strip clamp
51 Clamping member
52, 53 Guide bar
54, 55 Clamping jaw
56 Contact pressure element
60, 61 Toothed segment
62, 63 Gear wheel
64, 65 Gate
66, 67 Roller
68 Transverse shaft
70, 71 Coupling element
72, 73 Clamping roller
B1 to B6 Strip
α, β Pivot angle
d Spacing
X, Y, Z Cartesian coordinates

1. A strip guiding device for guiding metallic strips (B1 to B6) in a strip processing system between an inlet conveying section and an outlet conveying section of the device, the strip guiding device comprising:
two conveying sub-sections of the strip disposed one on top of the other;
an inlet-side turnout device configured for selectively connecting the inlet conveying section to an inlet-side conveying sub-section end of one of the two conveying sub-sections;
an outlet-side turnout device configured for selectively connecting the outlet conveying section to an outlet-side conveying sub-section end of one of the two conveying sub-sections; and
for each conveying sub-section, one inlet-side separation device for inlet-side severing of a strip (B1 to B6) disposed in the respective conveying sub-section and one outlet-side separation device for the outlet-side severing of a strip (B1 to B6) disposed in the respective conveying sub-section;
wherein each turnout device has a movable clamping device for fixing a strip (B1 to B6) in the respective turnout device.

2. The strip guiding device as claimed in claim 1, further comprising one inlet-side separation device at each inlet side conveying sub-section for the inlet-side severing of a strip (B1 to B6) disposed in the respective inlet side conveying sub-section, the inlet side separation device is disposed so as to be located and fixed on each conveying sub-section.

3. The strip guiding device as claimed in claim 1, further comprising a respective inlet-side separation device for the inlet-side severing of the strips (B1 to B6) disposed in each of the conveying sub-sections, the inlet-side separation device being movable between the conveying sub-sections.

4. The strip guiding device as claimed in claim 1, further comprising one outlet-side separation device at each outlet side conveying sub-section for severing the outlet-side of a strip (B1 to B6) disposed in the outlet side conveying sub-section, the outlet-side separation devices are disposed to be fixed in location on each conveying sub-section.

5. The strip guiding device as claimed in claim 1, further comprising an outlet-side separation device for the outlet-side severing of each of the strips (B1 to B6) disposed in the outlet side conveying sub-sections, the outlet-side separation device being movable between the outlet side conveying sub-sections.

6. The strip guiding device as claimed in claim 1, further comprising each separation device has at least one pair of circular knives including an upper knife and a lower knife which and the pair of knives are capable of traveling transversely to a strip running direction of a strip (B1 to B6) in a synchronous and mutually parallel manner across the strip (B1 to B6), wherein the upper knife is disposed above the strip (B1 to B6) and the lower knife is disposed below the strip (B1 to B6).

7. The strip guiding device as claimed in claim 6, further comprising each separation device includes two pairs of circular knives which are disposed so as to be mutually spaced apart in the strip running direction.

8. The strip guiding device as claimed in claim 1, further comprising an inlet-side clamping device and an outlet-side clamping device for fixing a strip (B1 to B6) in each of the conveying sub-section, the respective clamping devices are disposed on each conveying sub-section so as to be fixed in location or displaceable parallel to a strip running direction of a strip (B1 to B6).

9. The strip guiding device as claimed in claim 8, further comprising:
at least one of the clamping devices includes two strip clamps for fixing a strip (B1 to B6), the two strip clamps being disposed on different sides of the strip (B1 to B6) in a direction transverse to a strip running direction so as to be mutually opposite; each clamping device having two clamping jaws which are acting together and are displaceable transversely to the strip running direction; and
a lateral peripheral region of the strip (B1 to B6) being so located and capable of being clamped between the clamping jaws such that one of the two clamping jaws of each clamping device bears on an upper side of the peripheral region of the strip, and the other clamping jaw bears on a lower side of the peripheral region of the strip.

10. The strip guiding device as claimed in claim 8, further comprising at least one of the clamping devices includes two clamping rollers between which two clamping rollers a strip (B1 to B6) is capable of being clamped, such that the first clamping roller bears on an upper side of the strip (B1 to B6), and the second clamping roller bears on a lower side of the strip (B1 to B6), and wherein at least one of the clamping rollers is capable of being driven.

11. The strip guiding device as claimed in claim 1, further comprising one respective connection device for connecting strip ends of two strips (B1 to B6) is disposed at the inlet side and the outlet side respectively on each conveying sub-section.

12. A strip processing system having an inlet conveying section, an outlet conveying section, and a strip guiding device for guiding metallic strips (B1 to B6), the strip guiding device being configured as claimed in claim 1.

13. A method for guiding metallic strips (B1 to B6) in a strip processing system between an inlet conveying section and an outlet conveying section by a strip guiding device configured as claimed in claim 1, the method comprising:
disposing a first strip (B1), in the inlet conveying section, in the outlet conveying section and in a first conveying sub-section, fixing of the first strip in the inlet-side turnout device by the movable clamping device of the inlet-side turnout device and fixing of the first strip in the outlet side turnout device by the movable clamping device of the outlet-side turnout device;
severing the first strip (B1) by an inlet-side separation device and by an outlet-side separation device, thereby dividing the first strip (B1) into an inlet-side third strip (B3) having a strip end that is fixed in the inlet-side turnout device, an outlet-side fourth strip (B4) having a strip end that is fixed in the outlet-side turnout device, and a fifth strip (B5) that is disposed in the first conveying sub-section;
moving the strip end of the third strip (B3) by the inlet-side turnout device to the inlet-side conveying sub-section end of the second conveying sub-section; and
moving the strip end of the fourth strip (B4), by the outlet-side turnout device, to the outlet-side conveying sub-section end of the second conveying sub-section.

14. The method as claimed in claim 13, further comprising fixing the first strip (B1), prior to the severing of the first strip, in the first conveying sub-section, the fixing being by an inlet-side clamping device and an outlet-side clamping device.

15. The method as claimed in claim 14, further comprising disposing a second strip (B2) in the second conveying sub-section, connecting the strip end of the third strip (B3) to the inlet-side strip end of the second strip (B2), and connecting the strip end of the fourth strip (B4) to the outlet-side strip end of the second strip (B2).

16. A method for guiding a strip via a strip guiding device, comprising:
advancing the strip through the strip guiding device;
directing the strip to advance through the strip guiding device by an inlet conveying device;
directing the strip on a first advancing pathway through the guiding device;
clamping the ends of the strip after halting advancement;
separating ends of the first clamped strip at an inlet side and an outlet side of the guiding device;
directing a second strip to also advance through the guiding device;
directing the second strip on a different second advancing pathway through the guiding device;
clamping the ends of the second strip after halting advancement;
separating ends of the second clamped strip at an inlet side and an outlet side of the guiding device;
continuing halting advancement of the second strip while permitting advancement of the first strip through the guiding device;
after treatment of the first strip on the first advancing pathway, guiding the first strip out of the guiding device; and
guiding the second strip out of the guiding device.

17. The method as claimed in claim 16, further comprising directing the first and second strips on one of the respective first and second advancing pathways thereof, and prior to such directing, selecting either the first or the second path for the directing for advancement of the strip then advancing.
